(19) United States
(12) Patent Application Publication
(10) Pub. No.: US 2012/0056588 A1
(43) Pub. Date: Mar. 8, 2012

(54) Use of Battery Energy for Power Grid Optimization and Electric Vehicle Charging

(76) Inventors: Eric James Cai, Macomb, MI (US); Steven Cai, Macomb, MI (US); Ying Cai, Beijing (CN)

(21) Appl. No.: 12/876,210

(22) Filed: Sep. 6, 2010

(51) Int. Cl. H02J 7/00

(52) U.S. Cl. 320/128

(57) ABSTRACT

The use of battery cells to store energy for EV charging and grid optimization and regulation service. The major components of the system and the benefits of such concept are also described.

### BACKGROUND OF THE INVENTION

1. Battery Technology

The energy density and cycle life of the Li-ion battery chemistries have improved significantly in the past 10 years. It is projected that by 2015, the cell energy density could pass 200 wh/kg, with room temperature cycle life >5000 cycles at 70% Depth of Discharge or >12000 cycles at 60% Depth of Discharge. We believe that it is reasonable to expect the battery cells used by stationary application to have a full capacity life (100-80% of the original capacity) of 7 years under maximum usage (5 re-charges a day), or 33 years under minimum usage (1 re-charge a day). The reduced capacity life (80-40% of the original capacity) could add another 4-7 years of usage under maximum usage condition.

Although the battery cell chemistry is capable of meeting the grid application requirements in theory, the real application of the technology is still lacking due to reliability concerns of large number of battery cell connections, as well as the limitation of battery state estimation accuracy and cell balancing techniques.

2. Battery to Grid Applications

Due to accelerated construction of digitized transformer substations in recent years, many new technologies such as digitized control, data communication using IEC61850 protocol are enabling the integration of large sized battery into the grid. In US and Europe, there were several projects that have demonstrated the feasibility of using battery power to provide load leveling and frequency regulation services, or use the battery to store renewable energy. However, the technology is still in its infancy stage due to cost and battery management system technical limitations.

3. DC Fast Charging

The basic hardware and software technology to convert grid AC power to DC for EV fast charge station is currently available. However, given the current grid capacity, it is expected that the vast amount of energy needed from EV Fast charge stations would put significant stress on the existing grid structure and may reduce the grid operating efficiency. Another challenge is the lack of standards governing DC charge coupler geometry and data exchange protocol between EV battery management system and charging station control system. It is expect that the standards will be finalized globally by 2012.

There has not been any application of using a large size battery as energy source to power the DC fast charge station, mainly due to cost and battery management system limitations.

4. Integration of DC Fast Charging and Grid Optimization Functions using Battery Stored Energy

Now it is found by the inventors herein that, even though there are existing technologies that can be used to provide grid optimization services using battery stored energy; or to convert grid AC power to DC for EV fast charge services, there has not been any system available that can provide both DC fast charge and grid optimization services at the same time using battery as energy source.

### DESCRIPTION OF THE INVENTION

This invention relates to the concept of a Grid Optimizing Charge System that uses energy stored in battery to provide DC fast charge to electric vehicles while also functions as a grid load leveling energy source and frequency regulating device.

This Grid Optimizing DC Charge System (GOCS) will use a stationary battery matrix to store energy and will be connected to a high voltage power grid at all time. The charge or discharge of the battery will be controlled by specific algorithms that will enable the power grid to draw electricity from the battery matrix when needed or to charge the battery when the grid load is below certain level. The services that could be provided by this Grid Optimizing Charge System include, but are not limited to:
1. Electric Vehicle Charging—Functioning as a DC to DC charge station to provide electrical energy to electric vehicles
2. Load Shifting/Leveling—Applies a time based load management strategy to charge the battery matrix during non-peak periods, and discharge the electrical energy stored in the battery matrix back to the grid during peak periods
3. System Regulation—The bi-directional power electronic devices, which are part of this

Grid Optimizing Charge System, can be used as an effective power factor correction device to improve the grid efficiency. The battery matrix itself can also be controlled by the grid through battery management system to provide grid frequency regulation service.
4. Renewable Integration—To store electrical energy from renewable energy generating sources such as windmills, solar panels, etc.
5. Spinning Reserves—The electrical energy stored in the battery matrix can be rapidly deployed back to the grid creating the capacity to respond to an unexpected power demand, thus reducing the need of spinning reserves at power generating plants
6. Load Shaping—Following a signal or schedule, the charging load can be dynamically shaped according to grid needs for efficiency optimization.
7. UPS—Provide uninterrupted backup power to critical facilities and emergency services during power outage

The use of a battery matrix as a multi-purpose energy source will not only promote the large scale adoption of electric vehicles by providing DC fast charge services at a very high charge rate (>200 kW), it will also enable power plants to operate more efficiently and emit less pollution by running at a constant optimized power output, hence reducing the associated emissions of CO2, SO2, and NOx substantially compared to traditional power plant ancillary services. The response time of the battery matrix is superior to how the grid operates today. It can respond in milliseconds instead of minutes, which is the traditional power plant response time to vary their power output.

### DETAILED DESCRIPTION

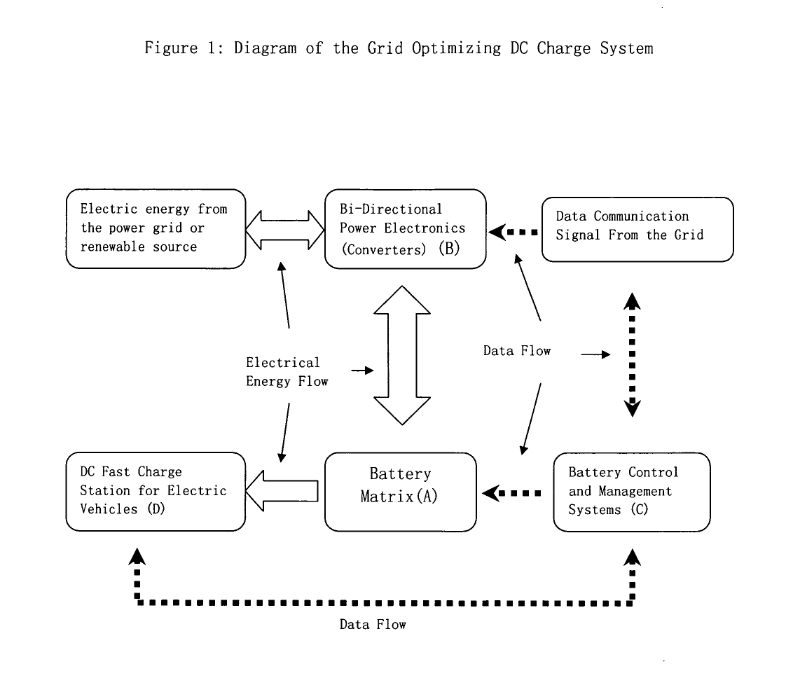

This Grid Optimizing DC Charge System (See FIG. 1 on drawing sheet) consists of: (A) a matrix of thermally managed battery cells, (B) bi-directional power electronic devices (Inverters), (C) a battery control and management system including control algorithm and sensing units, and (D) Direct Current charging interface devices and charge ports.

The matrix of battery cells are connected to the grid power at all times through the bi-directional power electronic devices (inverters), which will work with the battery management system to control the charge or discharge of the battery based on grid command or internal battery management system control algorithms. The electrical energy stored in battery cells can also flow through DC charging interface devices and charge ports to charge up multiple electric vehicles at the same time.

The battery management system will ensure that the battery matrix functions under optimal conditions through temperature control, cell balancing, and state of charge management. It will also manage the data communication between the charge station and power grid, and command the safety system of the battery matrix.

I. Battery Matrix (A):
The matrix is an array of the battery cells arranged in parallel-series-parallel-series format that provides the highest reliability, robustness and serviceability.
A group of cells are parallel connected to form a module. Each module will have sensors that measure temperature, voltage and current to be used for battery state estimation. The modules then get linked in series to form a case, and a stack of those cases are parallel connected to form a rack. The overall matrix is consisted of multiple racks connected in series.
The cooling of the modules can be either air cooled using chilled air or liquid cooled using heat sink under each case with “Quick Connect” to the rack cooling loop.
The rack will be designed in such ways that each of the series connected racks can be isolated by a contactor controlled by BMS in case of an emergency or service needs. There will be a smart active loss of isolation detection device installed for each rack for safety protection. The whole matrix can be serviced at case level—meaning each case can be pulled out of a rack without interrupting the rack or overall matrix system functionality. It also has the flexibility to increase the total matrix capacity by stacking more cases to the rack while maintaining the same DC voltage range, hence negate the need to change power electronics equipment for capacity expansion or reduction.

II. Bi-directional Power Electronics (B)
The Power Electronics Management System allows control of both real power (P) and reactive power (Q) based on the system requirement. Advanced control features allow multiple grid optimizing services to be provided to the grid at the command of its central/regional control center.

III. Battery Management System (C)
Battery State Estimator algorithm: We can predict the battery matrix SOC (State Of Charge) with accuracy of <3% anywhere within the operating SOC window. The battery state estimator algorithm takes into the consideration of cell temperature, current, and voltage of each cell, and uses them as inputs into a proprietary algorithm to predict cell state of charge. The SOC control is one of the most critical factors that determines the cycle life of the battery matrix, it is also being used to calculate how much stored energy is available to service the grid and electric vehicles
Power and SOC limit: The battery cells are tested to sustain 3 C charge and discharge rate without significant degradation of the cell chemistry. At 3 C discharge rate limit, a fully charged battery matrix can discharge 6 MW of power for 20 minutes, enough to provide electricity to 6000 homes for half hour. The BMS control software will manage the speed of the discharged through battery power limiting under different operating conditions. It will also control the depth of discharge (DoD) of the battery to maximize the life of the cells. Under normal condition, the DoD will be maintained at 80% of the total capacity
Balancing strategy: The cell/module will be actively balanced for long cycle life and high utilization efficiency. To conserve energy and reduce heat generation, the balancing will be done inductively instead of resistively every time when the battery is fully charged.
Automatic detection of cell and module failures: There will be a proprietary method to automatically detect any wiring or cell failure within the battery matrix. Upon such detection, the BMS control module can send out a warning signal to alert the operator of the problem area. In case of severe failures, it can also automatically disengage contactors to isolate the failed section of the battery matrix.

IV. DC Fast Charge Station (D)
Charge port—Will use Level 2 and Level 3 SAE AC/DC hybrid or IEC AC/DC hybrid charge port design for charge spots.
Charge Station to vehicle communication—charge time and charge rate will be controlled by vehicle battery management system. Pre-charge communication between the two devices will verify the battery condition and safety status using CAN or PLC protocol per SAE/IEC standards.

For the purposes of describing and defining the present invention it is noted that the term “device” is utilized herein to represent a combination of components and individual components, regardless of whether the components are combined with other components.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. The concept of using batteries to store energy for DC charging and power grid regulation and optimization as shown and described.

2. The major components/systems required to enable such Grid Optimizing Charge System concepts as shown and described.
